(19) United States
(12) Patent Application Publication
(10) Pub. No.: US 2020/0123396 A1
(43) Pub. Date: Apr. 23, 2020

(54) PRODUCTS PRESERVED WITH 5-CHLORO-2-METHYL-4-ISOTHIAZOLIN-3-ONE

(71) Applicant: THOR GMBH, Speyer (DE)

(72) Inventors: Peter Erich HAHN, Lampertheim (DE); Hans-Jürgen SCHMIDT, Speyer (DE); Rüdiger BAUM, Waghausel (DE); Thomas WUNDER, Neustadt a.d. Weinstrasse (DE)

(21) Appl. No.: 16/721,689

(22) Filed: Dec. 19, 2019

Related U.S. Application Data
(62) Division of application No. 15/508,445, filed on Mar. 2, 2017.

(30) Foreign Application Priority Data
Sep. 2, 2014 (EP) 14003016.4

(51) Int. Cl. C09D 5/14; C09D 133/02; A01N 59/16; A01N 43/40; A01N 43/80; C09D 5/02

(52) U.S. Cl. CPC C09D 5/14; C09D 133/02; C09D 5/025; A01N 43/40; A01N 43/80; A01N 59/16

(57) ABSTRACT

The invention relates to preserved products which contain 1 to 100 ppm of 5-chloro-2-methyl-4-isothiazolin-3-one with a content of 2-methyl-4-isothiazolin-3-one in the range from 0 to 2 wt. % based on the total amount of 5-chloro-2-methyl-4-isothiazolin-3-one, and to the use of 5-chloro-2-methyl-4-isothiazolin-3-one with a content of 2-methyl-4-isothiazolin-3-one in the range from 0 to 2 wt. % based on the total amount of 5-chloro-2-methyl-4-isothiazolin-3-one, for the preservation of products.

The invention relates to preserved products which comprise 1 to 100 ppm of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one, and also to the use of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one. The present invention further relates to a process for reducing microbial infestation of products, using 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one.

Industrial products, especially aqueous products, such as paints, varnishes, emulsions, and cosmetic products, are typically produced using natural or biodegradable raw materials. These raw materials and the water used as solvent are frequently burdened with microbes, such as bacteria, yeasts and fungi. In the absence of any preservation during the production of these products, they may have high microbe counts just a day after their production.

In order to ensure that these products meet the requirements of hygiene and hence that the durability of the industrial products is ensured, agents known as biocides are added to the products. One of these biocides is 5-chloro-2-methylisothiazolin-3-one (CMIT). This biocide has good biocidal activity, but has various drawbacks in terms of practical handling. This compound may, for example, trigger allergies in persons dealing with it.

In order to overcome the drawbacks of this CMIT, which, though being extremely effective, also carries drawbacks for the end user, the mixture disclosed in EP 1 005 271 B1 has been used as a biocide composition from the beginning of the 1990s, this being a mixture of the isothiazolinones 2-methylisothiazolin-3-one (MIT) and 1,2-benzisothiazolin-3-one (BIT). This mixture is sold as Acticide® MBS by Thor GmbH (Speyer, Federal Republic of Germany) and is presently the standard in the in-can preservation of waterborne paints and renders. A plus point of this biocide composition is that, as a result of skillful selection of the two isothiazolinones, it combines high activity with a potential for sensitization that is significantly low in comparison to that of 5-chloro-2-methylisothiazolin-3-one.

Despite the switch to Acticide® MBS as an alternative to 5-chloro-2-methylisothiazolin-3-one, the products preserved using Acticide® MBS still always include MIT, which in allergics and/or in persons having a high degree of sensitization may bring about contact eczemas and also aerogenic contact eczemas.

In view of the circumstances outlined at the outset, however, there is no possibility of abandoning effective preservatives entirely.

One possible solution is proposed in published German patent application DE 198 10 819 A1. That document is concerned with a method for producing coating materials which are to be suitable for persons reacting allergically to isothiazolinones. As part of the method, the coating materials containing the isothiazolinones are admixed with reagents, such as sodium thiosulfate, which are intended through chemical reaction to decompose the isothiazolinone(s) in such a way as to form derivatives that are unobjectionable for persons reacting allergically.

A drawback, however, is that according to the method described, the isothiazolinones, and especially the MIT, are not destroyed quantitatively or irreversibly, and so are still always present in the products and derivatives, and may still as before cause problems to persons reacting allergically, and/or may give rise to contact eczemas or aerogenic contact eczemas in persons having a high degree of sensitization. Accordingly, as part of experiments conducted by the inventors, it was found that 2-methylisothiazolin-3-one present, for example, in an aqueous emulsion paint could be destroyed neither quantitatively nor irreversibly using sodium thiosulfate.

It is therefore an object of the present invention to provide products preserved with 5-chloro-2-methylisothiazolin-3-one (CMIT) which make it possible to produce therefrom not only 5-chloro-2-methylisothiazolin-3-one-free end products but also 2-methylisothiazolin-3-one-free end products.

A further object of the invention is to provide a process allowing products to be produced which are suitable even for persons reacting allergically to 5-chloro-2-methylisothiazolin-3-one and/or 2-methylisothiazolin-3-one, and/or for persons having a high degree of sensitization toward 5-chloro-2-methylisothiazolin-3-one and 2-methylisothiazolin-3-one. This process is not to forgo the use of 5-chloro-2-methylisothiazolin-3-one.

This object is achieved by means of a product selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants, comprising 1 to 100 ppm, preferably 5 to 50 ppm, of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one.

An advantageous feature of these products is that the 5-chloro-2-methyl-4-isothiazolin-3-one they contain can be decomposed in a manner familiar to the skilled person, allowing the production therefrom of (end) products which are free from 5-chloro-2-methylisothiazolin-3-one and 2-methylisothiazolin-3-one. Products of this kind are suitable in particular for persons having a high degree of sensitization toward 5-chloro-2-methylisothiazolin-3-one and/or 2-methylisothiazolin-3-one.

The concept of the present invention therefore enables the stated products, using the extremely effective 5-chloro-2-methylisothiazolin-3-one, to be preserved during production, and treated prior to commercial introduction, in such a way that the end product no longer contains any 5-chloro-2-methylisothiazolin-3-one that might cause problems to persons having a high degree of sensitization toward 5-chloro-2-methylisothiazolin-3-one. The use of 5-chloro-2-methylisothiazolin-3-one during the production of the products has the advantage that by means of this highly effective broad-spectrum biocide, the microorganisms introduced by the individual ingredients of the products in question can be efficiently inactivated, thus giving, after the deliberate destruction of the 5-chloro-2-methylisothiazolin-3-one, virtually sterile products which can be further preserved by means of biocides which preferably do not have the drawbacks described at the outset.

The term “product” in the sense of the present invention denotes the above-recited products and/or systems selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants. The term “product” here refers both to end products and intermediates. According to one particularly preferred embodiment of the invention, the product is a polymer emulsion or the precursor product of an interior paint or plaster. Precursor product here means that these products, before being introduced commercially, are treated in such a way that the 5-chloro-2-methylisothiazolin-3-one present in the products is decomposed, ideally quantitatively.

According to one preferred embodiment of the invention, the product comprises 5-chloro-2-methylisothiazolin-3-one having a 2-methyl-4-isothiazolin-3-one content in the range from 0 to 2 wt %, based on the total fraction of the 5-chloro-2-methyl-4-isothiazolin-3-one, in an amount, based on the product, in the range from 1 ppm to 100 ppm, preferably in the range from 5 ppm to 50 ppm, more preferably in the range from 5 ppm to 30 ppm.

The industrial manufacture of 5-chloro-2-methylisothiazolin-3-one and 2-methylisothiazolin-3-one, respectively, is known and can take place in a variety of ways, all of which yield a mixture of 5-chloro-2-methylisothiazolin-3-one and 2-methylisothiazolin-3-one. U.S. Pat. No. 3,849,430 A, for example, describes two alternatives, which yield a mixture of 5-chloro-2-methylisothiazolin-3-one and 2-methylisothiazolin-3-one, respectively. As described at the outset, the 2-methylisothiazolin-3-one present in the mixture of 5-chloro-2-methylisothiazolin-3-one and 2-methylisothiazolin-3-one cannot readily be destroyed, and so (end) products preserved with 2-methylisothiazolin-3-one may cause problems to allergics and/or persons having a high degree of sensitization toward 2-methylisothiazolin-3-one. One way of circumventing this problem scenario would be to give up entirely on the use of the 5-chloro-2-methylisothiazolin-3-one containing 2-methylisothiazolin-3-one.

The present invention, however, allows the further use of 5-chloro-2-methylisothiazolin-3-one, in the form of an entirely innovative mixture, which comprises the 2-methyl-4-isothiazolin-3-one in the range from 0 to 2 wt %, based on the total fraction of the 5-chloro-2-methyl-4-isothiazolin-3-one, preferably in the range from 0 to 1 wt o, based in each case on the total fraction of the 5-chloro-2-methyl-4-isothiazolin-3-one.

According to one embodiment of the invention, the products are characterized in that they contain less than 1 ppm, preferably less than 0.1 ppm, more preferably 0.01 ppm of 2-methyl-4-isothiazolin-3-one, based in each case on the product. The 2-methyl-4-isothiazolin-3-one present in the products may have been introduced into the product through addition of the 5-chloro-2-methyl-4-isothiazolin-3-one containing the 2-methyl-4-isothiazolin-3-one in the range from 0 to 2 wt %. According to an alternative embodiment of the invention, however, the 2-methyl-4-isothiazolin-3-one may also have been introduced via other ingredients of the products - for example, via product ingredients preserved using 2-methyl-4-isothiazolin-3-one.

As described above, the industrial manufacture of 5-chloro-2-methylisothiazolin-3-one and 2-methylisothiazolin-3-one always yields a mixture of 5-chloro-2-methylisothiazolin-3-one and 2-methylisothiazolin-3-one. While biocide compositions containing 2-methylisothiazolin-3-one are available commercially with a small fraction of 5-chloro-2-methylisothiazolin-3-one, 5-chloro-2-methyl-4-isothiazolin-3-one compositions having a 2-methyl-4-isothiazolin-3-one content in the range from 0 to 2 wt %, based on the total fraction of the 5-chloro-2-methyl-4-isothiazolin-3-one, are not available commercially.

A skilled person is able to produce 5-chloro-2-methyl-4-isothiazolin-3-one compositions having the small 2-methyl-4-isothiazolin-3-one fraction required by the invention, from mixtures of 5-chloro-2-methylisothiazolin-3-one and 2-methylisothiazolin-3-one, by means of separation techniques with which he or she is familiar, such as chromatography, extraction and/or fractional precipitation. The skilled person is able to determine the purity of the 5-chloro-2-methyl-4-isothiazolin-3-one and/or the amount thereof in the products in question by means of methods with which he or she is familiar, such as by quantitative HPLC, for example.

The product comprising 1 to 100 ppm of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one, is generally selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants.

Since the product of the invention is envisioned in particular for allergics, and/or for persons having a high degree of sensitization toward 5-chloro-2-methylisothiazolin-3-one and/or 2-methylisothiazolin-3-one, the product is preferably selected from the group consisting of interior paints, plasters, polymer dispersions, and cosmetic products. From these products it is possible, advantageously, to produce end products which contain neither 5-chloro-2-methylisothiazolin-3-one nor 2-methylisothiazolin-3-one, and are therefore suitable for allergics, and/or for persons having a high degree of sensitization toward 5-chloro-2-methylisothiazolin-3-one and/or 2-methylisothiazolin-3-one.

According to a further embodiment of the invention, the product is a water-based product. The water content in this case is generally in the range from 5 to 99.9 wt %.

The present invention further relates to the use of 5-chloro-2-methyl-4-isothiazolin-3-one having a 2-methyl-4-isothiazolin-3-one content in the range from 0 to 2 wt %, preferably having a 2-methyl-4-isothiazolin-3-one content in the range from 0 to 1 wt %, based on the total fraction of the 5-chloro-2-methyl-4-isothiazolin-3-one, for reducing microbial infestation of a product, characterized in that the product is selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants. According to one preferred embodiment of the invention, the product is selected from the group consisting of interior paints, plasters, polymer dispersions, and cosmetic products.

The phrase “for reducing microbial infestation of a product” in the sense of the invention means that by introduction of an amount of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one, into the product, the microbial growth of the microorganisms present in the products is demonstrably slowed or prevented entirely.

The amount of 5-chloro-2-methyl-4-isothiazolin-3-one introduced into the products in question is generally, based on the product, in the range from 1 ppm to 100 ppm, preferably in the range from 5 ppm to 50 ppm, more preferably in the range from 5 ppm to 30 ppm.

In an advantageous way, the inventive use of 5-chloro-2-methyl-4-isothiazolin-3-one having the above-defined 2-methyl-4-isothiazolin-3-one content makes it possible to obtain preserved products whose preservative can be deliberately decomposed at any desired point in time in an easy way, allowing the production thereby of (end) products which are free from 5-chloro-2-methyl-4-isothiazolin-3-one and also from 2-methyl-4-isothiazolin-3-one.

According to one preferred embodiment, the present invention relates to the use of a biocide composition for reducing microbial infestation of a product.

This biocide composition is characterized in that it comprises the following components, or consists of the following components:
a) from 0.25 to 40 wt %, preferably 0.25 to 20 wt %, more preferably 0.25 to 2 wt % of chloro-2-methyl-4-isothiazolin-3-one having a 2-methyl-4-isothiazolin-3-one content in the range from 0 to 2 wt %, preferably having a 2-methyl-4-isothiazolin-3-one content in the range from 0 to 1 wt %, based on the total fraction of the 5-chloro-2-methyl-4-isothiazolin-3-one, and
b) a solvent.

This biocide composition has a pH in the range from pH 1 to 5, preferably in the range from pH 2 to 4.

According to one preferred embodiment of the invention, the biocide composition further comprises at least one stabilizer selected from group c), d), e), and f):
c) from 0.1 to 25 wt % of a metal nitrate
d) from 0.1 to 500 ppm of copper ions (Cu²⁺)
e) from 5 ppm to 10 000 ppm of an oxidizing agent
f) from 5 ppm to 1000 ppm of 2-bromo-2-nitropropane-1,3-diol and/or formaldehyde.

According to one preferred embodiment of the invention, the solvent b) is a polar solvent, preferably water.

The metal nitrate which may be present as stabilizer c) in the biocide composition in an amount, based on the total biocide composition, of 0.01 to 25 wt %, preferably in an amount of 2 to 10 wt %, is preferably a nitrate salt of an alkali metal or alkaline earth metal. The metal in question is preferably lithium, sodium, potassium, magnesium, calcium, or mixtures of these metals. With particular preference the metal nitrate is magnesium nitrate and or sodium nitrate.

The copper ions which may be present as stabilizer d) in the biocide composition in an amount, based on the total biocide composition, in the range from 0.1 to 500 ppm, preferably 1 to 10 ppm, are copper(II) ions. According to one preferred embodiment of the invention, these ions are introduced into the biocide composition via copper(II) nitrate and/or copper(II) sulfate.

The at least one oxidizing agent which may be present as stabilizer e) in the biocide composition in an amount, based on the total biocide composition, in the range from 5 to 10 000 ppm, preferably in the range from 10 to 2000 ppm, more preferably in the range from 10 to 50 ppm, is generally at least one oxidizing agent selected from the following group: hydrogen peroxide, iodate, periodate, perchlorate, chlorate, bromate, and/or the halogen oxo acids derived accordingly, organic oxidizing agents, preference being given to hydrogen peroxide, iodate, periodate, and bromate, and particular preference to iodate. The stated oxidizing agents may be introduced into the biocide composition in a conventional way, in the form of their alkali metal salts, for example.

As stabilizer f), the biocide composition may also comprise formaldehyde and/or 2-bromo-2-nitropropane-1,3-diol in an amount, based on the total biocide composition, in the range from 5 to 1000 ppm, preferably in the range from 10 to 200 ppm. Formaldehyde in this case may also be introduced into the biocide composition in the form of what is called a formaldehyde donor.

“Comprising at least one stabilizer selected from the group of c), d), e), and f)” in the sense of the present invention means that in addition to the components a), the chloro-2-methyl-4-isothiazolin-3-one, and component b), the solvent, the biocide composition comprises one or more stabilizers from groups c), d), e), and f).

The biocide compositions are preferably in liquid form. The term “liquid” in this context means that the biocide composition is in the liquid aggregate state at room temperature and the amount of undissolved constituents is 0 to 1 wt %, preferably 0 to 0.5 wt %. With particular preference the liquid biocide compositions are free from undissolved constituents.

According to one preferred embodiment of the present invention, the biocide composition is characterized in that it has a pH in the range from pH 1 to 5, preferably in the range from pH 2 to 4, and comprises the following components, or consists of the following components:
a) from 0.25 to 2 wt % of chloro-2-methyl-4-isothiazolin-3-one having a 2-methyl-4-isothiazolin-3-one content in the range from 0 to 2 wt %, preferably having a 2-methyl-4-isothiazolin-3-one content,
b) from 98 to 99.74 wt % of water, and at least one stabilizer selected from the group d) and e):
d) from 0.1 to 20 ppm of copper(II) ions,
e) from 5 ppm to 10 000 ppm of an oxidizing agent.

As already described above, the biocide composition is added to the products to be preserved in an amount such that the amount of 5-chloro-2-methyl-4-isothiazolin-3-one introduced into the products in question, based on the product, is in the range from 1 ppm to 100 ppm, preferably in the range from 5 ppm to 50 ppm, more preferably in the range from 5 ppm to 30 ppm.

According to a further embodiment, the invention relates to a polymer emulsion comprising 5-chloro-2-methyl-4-isothiazolin-3-one having a 2-methyl-4-isothiazolin-3-one content in the range from 0 to 2 wt %, preferably having a 2-methyl-4-isothiazolin-3-one content in the range from 0 to 1 wt %, based on the total fraction of the 5-chloro-2-methyl-4-isothiazolin-3-one. The polymer emulsion is further characterized in that it comprises the 5-chloro-2-methyl-4-isothiazolin-3-one in an amount in the range from in the range from 1 ppm to 100 ppm, preferably in the range from 5 ppm to 50 ppm, more preferably in the range from 5 ppm to 30 ppm.

“Polymer emulsion” in the sense of the present invention means an emulsion which includes a solvent which comprises water in which at least one polymer is dispersed. The polymer comprises the solids content amounts of the aqueous polymer emulsion. The solvent preferably comprises at least 35 wt % of water. More preferably still, the solids content of the aqueous polymer emulsion is 25 to 65 and very preferably 35 to 55 wt %. Polymer emulsions of this kind are used preferably in the production of paints and renders.

According to a further embodiment, the present invention relates to the use of the above-described 5-chloro-2-methyl-4-isothiazolin-3-one-containing polymer emulsion for producing coatings, such as paints and renders.

The use of the polymer emulsion for producing a paint or a render has the advantage here that it is possible to produce paints and renders preserved therewith that before being introduced commercially can be treated in such a way that they subsequently no longer contain any 5-chloro-2-methylisothiazolin-3-one.

The present invention further relates to a process for reducing microbial infestation of a product, comprising the steps of:
(A) providing a product having a 2-methyl-4-isothiazolin-3-one content in the range from 0 to 1 ppm, and
(B) adding 1 to 100 ppm of 5-chloro-2-methyl-4-isothiazolin-3-one having a 2-methyl-4-isothiazolin-3-one content in the range from 0 to 2 wt %, preferably 0 to 1 wt %, based on the total fraction of the 5-chloro-2-methyl-4-isothiazolin-3-one.

“Reducing microbial infestation of a product” in the sense of the process of the invention means that by introduction of an amount of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one, into the product to be preserved, the microbial growth of the microorganisms present in the products is demonstrably slowed or prevented entirely.

The product provided in process step (A) is generally characterized in that it has a 2-methyl-4-isothiazolin-3-one content in the range from 0 to 1 ppm, based on the product. According to one preferred embodiment of the invention, the product provided in process step (A) has a 2-methyl-4-isothiazolin-3-one content in the range from 0.1 ppm to 0 ppm, and of 0 ppm according to one particularly preferred embodiment. Owing to the negligibly small 2-methyl-4-isothiazolin-3-one content of the product provided, the process of the invention, using 5-chloro-2-methyl-4-isothiazolin-3-one having the above-defined 2-methyl-4-isothiazolin-3-one content, can be used to produce preserved products whose preservative can be deliberately decomposed at any desired point in time, in a simple way, such that it is possible as a result to obtain (end) products which are free from 5-chloro-2-methyl-4-isothiazolin-3-one and 2-methyl-4-isothiazolin-3-one.

The product provided in process step (A) is generally selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants. According to one preferred embodiment of the invention, the product is selected from the group consisting of interior paints, plasters, polymer dispersions, and cosmetic products.

In process step (B), the product is admixed with 1 to 100 ppm, preferably 5 to 50 ppm, more preferably 5 to 30 ppm of 5-chloro-2-methyl-4-isothiazolin-3-one having a 2-methyl-4-isothiazolin-3-one content in the range from 0 to 2 wt %, preferably having a 2-methyl-4-isothiazolin-3-one content in the range from 0 to 1 wt %, based on the total fraction of the 5-chloro-2-methyl-4-isothiazolin-3-one. As a result, a product is obtained which is preserved with 5-chloro-2-methyl-4-isothiazolin-3-one and whose preservative can be deliberately decomposed at any desired point in time, in a simple way.

According to one preferred embodiment, the process of the invention comprises, as a further process step, process step (C). Within process step (C), the 5-chloro-2-methyl-4-isothiazolin-3 added in process step (B) is decomposed by means of at least one 5-chloro-2-methyl-4-isothiazolone-decomposing compound.

The invention therefore also relates to a process for reducing microbial infestation of a product, comprising the steps of:
(A) providing a product having a 2-methyl-4-isothiazolin-3-one content in the range from 0 to 1 ppm,
(B) adding 1 to 100 ppm of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one, and
(C) decomposing the 5-chloro-2-methyl-4-isothiazolin-3-one by means of at least one 5-chloro-2-methyl-4-isothiazolone-decomposing compound.

In step (C) of the process of the invention, the 5-chloro-2-methyl-4-isothiazolin-3-one used for reducing microbial infestation is decomposed or degraded by means of at least one 5-chloro-2-methyl-4-isothiazolone-decomposing compound.

The 5-chloro-2-methyl-4-isothiazolone here is preferably degraded or decomposed in such a way that the amount of 5-chloro-2-methyl-4-isothiazolone in the product within a period of less than 24 hours after addition of the at least one 5-chloro-2-methyl-4-isothiazolone-decomposing compound, based on the total product, is subsequently only in a range from 0 to 0.5 ppm, preferably in the range from 0 to 0.1 ppm.

“Decomposition of the 5-chloro-2-methyl-4-isothiazolone” for the purposes of the present invention means that the 5-chloro-2-methyl-4-isothiazolone in process step (C) is irreversibly decomposed or degraded within a period of up to 24 hours, preferably within a period of 0.5 to 12 hours, more preferably within a period of 2 to 6 hours, so that after this period the amount of 5-chloro-2-methyl-4-isothiazolone, based on the product, is in the range from 0 to 0.5 ppm, more preferably in the range from 0 to 0.1 ppm.

Within a period of up to 24 hours here means that the 5-chloro-2-methyl-4-isothiazolone which was added in process step (C) is decomposed within 24 hours, starting from the time of contact with the at least one 5-chloro-2-methyl-4-isothiazolone-decomposing compound, so that the total amount of 5-chloro-2-methyl-4-isothiazolone after these 24 hours is in the range from 0 to 0.5 ppm, based on the product.

Agent for decomposing the 5-chloro-2-methyl-4-isothiazolone for the purposes of the present invention means a compound which decomposes or inactivates the 5-chloro-2-methyl-4-isothiazolone by chemical reaction. The effect of the agent for decomposing the 5-chloro-2-methyl-4-isothiazolone is that the 5-chloro-2-methyl-4-isothiazolone present in the product is reduced within the above-defined periods to the amount in the range from 0 to 0.5 ppm. Agents and compounds of this kind are known to the skilled person. Selecting them is therefore a matter of routine for the skilled person.

According to one preferred embodiment of the invention, the agent for decomposing the 5-chloro-2-methyl-4-isothiazolone comprises at least one thiol compound.

According to one particularly preferred embodiment of the invention, the agent used in process step (C) for decomposing the 5-chloro-2-methyl-4-isothiazolone comprises at least one compound selected from the group consisting of cysteine, mercaptoethanol, mercaptopropionic acid, methyl mercaptopropionate, glutathione, thioglycolate, sodium thiosulfate, sodium bisulfite, pyrithione, mercaptopyridine, dithiothreitol, mercaptoethanesulfonate, and sodium formaldehyde sulfoxylate. According to one particularly preferred embodiment of the invention, the agent for decomposing the 5-chloro-2-methyl-4-isothiazolone comprises cysteine.

The amount of the compound(s) used for decomposing the 5-chloro-2-methyl-4-isothiazolone, and the molar ratio thereof relative to the 5-chloro-2-methyl-4-isothiazolone present in the products, may vary over wide ranges. Customarily, the molar ratio of the 5-chloro-2-methyl-4-isothiazolone to the at least one compound with which it is decomposed is in the range from 20:1 to 1:20, preferably in the range from 5:1 to 1:5, more preferably in the range from 2:1 to 1:2.

According to one preferred embodiment of the invention, the process of the invention is characterized in that cysteine in an amount in the range from 1 to 200 ppm, preferably 5 to 25 ppm, based on the product, is used for decomposing the 5-chloro-2-methyl-4-isothiazolone in process step (C).

According to one preferred embodiment of the invention, the agent for decomposing the 5-chloro-2-methyl-4-isothiazolone comprises at least one zinc complex of cysteine. The present invention accordingly likewise relates to a process wherein the 5-chloro-2-methyl-4-isothiazolone is decomposed in process step (C) using or employing a composition comprising or consisting of:
(A) 0.1 to 20 wt %, preferably 2 to 10 wt %, of cysteine,
(B) 0.1 to 10 wt %, preferably 2 to 10 wt %, of a water-soluble zinc compound,
(C) 0 to 20 wt % of zinc oxide and/or zinc carbonate, and
(D) 55 to 99.8 wt % of water.

According to one embodiment, the composition comprises components (A), (B), (C), and (D), which means that in addition to these components there may also be other components, such as defoamers, dispersing assistants, biocides, and thickeners. According to an alternative embodiment of the invention, the composition contains exclusively components (A), (B), (C), and (D), or only components (A), (B), and (D), in the specified ranges.

The water-soluble zinc compound here is selected from the group consisting of zinc chloride, zinc acetate, zinc benzoate, zinc tartrate, zinc formate, zinc gluconate, zinc lactate, zinc laurate, zinc maleate, zinc nitrate, and zinc sulfate. According to one preferred embodiment, the water-soluble zinc compound comprises zinc sulfate and/or zinc chloride, more preferably zinc chloride.

According to one preferred embodiment, the at least one water-soluble zinc compound is used in equimolar amount relative to the cysteine.

The pH of the above-described compositions is generally in the range from 2.5 to 5.0, preferably in the range from 3.5 to 4.5. A skilled person is able to set the pH of the compositions using appropriate agents, such as hydrochloric acid.

According to one preferred embodiment, the above-described composition comprises or consists of:
(A) 0.1 to 5 wt %, preferably 2 wt %, of cysteine,
(B) 0.1 to 5 wt %, preferably 2 wt %, of a water-soluble zinc compound, preferably zinc chloride, and
(C) 90 to 99.8 wt % of water.

According to an alternative preferred embodiment, the above-described composition comprises or consists of:
(A) 5 to 20 wt %, preferably 10 wt %, of cysteine,
(B) 0.1 to 10 wt %, preferably 6 wt %, of a water-soluble zinc compound, preferably zinc chloride,
(C) 1 to 20 wt %, preferably 5 wt %, of zinc oxide, and
(D) 55 to 93.8 wt % of water.

The above-described compositions are notable for effective meterability and storage stability and additionally are optimized with regard to the elimination of hydrogen sulfide.

Following the decomposition of the 5-chloro-2-methyl-4-isothiazolin-3-one in process step (C), the product is indeed ideally free from microbial infestation, but is possibly still not protected against newly introduced microbes, owing to the preservative that is now absent. According to one embodiment of the invention, within the process of the invention, the pH in the product to be preserved is adjusted to a pH in the range from 9.5 to 12, preferably to a pH in the range from 11 to 12. The pH is preferably adjusted by addition of NaOH and/or KOH. In the case of an emulsion paint, the applicant has shown that this paint, after decomposition of the 5-chloro-2-methyl-4-isothiazolin-3-one and adjustment of the pH to a pH in the range from 9.5 to 12, possesses a storage stability of at least 6 months.

According to a further preferred embodiment, the process of the invention comprises as a further process step, process step (D), the addition of a further biocide.

The invention therefore likewise relates to a process for reducing microbial infestation of a product, comprising the steps of:
(A) providing a product having a 2-methyl-4-isothiazolin-3-one content in the range from 0 to 1 ppm,
(B) adding 5 to 100 ppm of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one,
(C) decomposing the 5-chloro-2-methyl-4-isothiazolin-3-one by means of at least one 5-chloro-2-methyl-4-isothiazolone-decomposing compound, and
(D) adding a further biocide.

The biocide added in process step (D) serves for ongoing preservation of the products originally preserved with 5-chloro-2-methyl-4-isothiazolin-3-one. As a result of the decomposition of the 5-chloro-2-methyl-4-isothiazolin-3-one in process step (C), the products are indeed ideally free from microbial infestation, but are possibly now not adequately protected against newly introduced microbes, owing to the preservative that is now absent. In order to provide this protection, at least one further biocide is added in process step (D), and is selected by the skilled person on the basis of his or her common general knowledge, depending on the product requiring ongoing preservation. The amount in which the at least one biocide added in process step (D) is used may also be determined by the skilled person on the basis of his or her common general knowledge.

According to one preferred embodiment of the invention, the process is characterized in that the biocide added in process step (D) is at least one selected from the group consisting of 1,2-benzisothiazolin-3-one, 2-bromo-2-nitropropane-1,3-diol, zinc 2-mercaptopyridine N-oxide, a silver source, a zinc source, and 2,2-dibromo-3-nitrilopropionamide.

Zinc source or silver source here denotes compounds consisting of zinc or silver salts, zinc silver oxides, zinc or silver hydroxides, zinc or silver sulfates, zinc or silver chlorides, zinc or silver metals, zinc or silver complexes, and combinations thereof. Preferred zinc sources here are selected from the group consisting of zinc acetate, zinc oxide, zinc carbonate, zinc chloride, zinc sulfate, zinc hydroxide, zinc citrate, zinc fluoride, zinc iodide, zinc lactate, zinc oleate, zinc oxalate, zinc phosphate, zinc propionate, zinc salicylate, zinc selenate, zinc silicate, zinc stearate, zinc sulfide, zinc tannate, zinc tartrate, zinc gluconate, zinc undecylate, and of combinations thereof. Preferred silver sources here are selected from the group consisting of silver bromide, silver chloride, silver citrate, silver iodide, silver lactate, silver nitrate, silver oxide, and of combinations thereof.

According to one preferred embodiment, the biocide added in process step (D) comprises a combination of a silver source and 1,2-benzisothiazolin-3-one. According to an even more preferred embodiment, the biocide added in process step (D) comprises a combination of silver source, zinc source, and 1,2-benzisothiazolin-3-one. The amount in which the above-defined compositions are used may vary over wide ranges. A skilled person is able to determine these ranges on the basis of his or her common general knowledge, without taking an inventive step.

According to an alternative preferred embodiment, the biocide added in process step (D) is a combination of 1,2-benzisothiazolin-3-one and a pyrithione compound, such as zinc 2-mercaptopyridine N-oxide (zinc pyrithione). Further preferred, moreover, is the addition of a zinc source, such as zinc oxide. The amount in which the above-defined compositions are used may vary over wide ranges. A skilled person is able to determine these ranges on the basis of his or her common general knowledge, without taking an inventive step.

According to an alternative preferred embodiment, the biocide added in process step (D) is a combination of a silver source, 1,2-benzisothiazolin-3-one, and a pyrithione compound, such as zinc 2-mercaptopyridine N-oxide (zinc pyrithione). The amount in which the above-defined compositions are used may vary over wide ranges. A skilled person is able to determine these ranges on the basis of his or her common general knowledge, without taking an inventive step.

According to an alternative preferred embodiment, the biocide added in process step (D) is 2-bromo-2-nitropropane-1,3-diol and/or 2,2-dibromo-3-nitrilopropionamide. The amount in which the above-specified biocides are used may vary over wide ranges. A skilled person is able to determine these ranges on the basis of his or her common general knowledge, without taking an inventive step.

The present invention is described in more detail using the example set out below:

Added to a preservative-free styrene-acrylate dispersion were 20 ppm of 5-chloro-2-methylisothiazolin-3-one, having a 2-methylisothiazolin-3-one content of <1 wt %. The styrene-acrylate dispersion thus preserved was then used for producing a water-based emulsion paint. The composition of the paint produced was as follows:
25.7 wt % water
0.2 wt % acrylate-based wetting and dispersing agent
0.2 wt % mineral oil-based defoamer
2.0 wt % water softener (sodium polyphosphate)
0.2 wt % ammonia
4.0 wt % titanium oxide (pigment)
51.0 wt % calcium carbonate (filler)
5.0 wt % talc (filler)
0.4 wt %% cellulose ether
2.0 wt % organic solvent for lowering the minimum film-forming temperature
9.0 wt % the styrene-acrylate dispersion preserved with 20 ppm of 5-chloro-2-methylisothiazolin-3-one
20 ppm 5-chloro-2-methylisothiazolin-3-one, having a 2-methylisothiazolin-3-one content of <1 wt %

By means of microbiological investigations, no microbial growth was found in the emulsion paint, whereas microbial growth was detectable in individual components. The highly active 5-chloro-2-methylisothiazolin-3-one was therefore sufficient to cause complete killing of the microorganisms introduced via the individual components of the paint.

In order, from the emulsion paint, which contained significant quantities of 5-chloro-2-methylisothiazolin-3-one, to produce a paint unobjectionable for allergics in relation to 5-chloro-2-methylisothiazolin-3-one and 2-methylisothiazolin-3-one present therein, to produce, these isothiazolin-3-ones were decomposed by addition of 50 ppm of cysteine, based on the emulsion paint. After just 3 hours, 5-chloro-2-methylisothiazolin-3-one was no longer detectable in the emulsion paint by HPLC.

The paint thus produced was now free from microorganisms, through the use of the effective broad-spectrum biocide 5-chloro-2-methylisothiazolin-3-one, but as a consequence of the decomposition of the biocide by the cysteine, it was susceptible to newly introduced microorganisms which may enter the paint in the course of storage.

In order to protect the paint against such microbial infestation during storage, therefore, 50 ppm of 1,2-benzisothiazolin-3-one, 100 ppm of zinc 2-mercaptopyridine N-oxide (zinc pyrithione) and 10 ppm of zinc oxide were added, based on the emulsion paint, for ongoing preservation. The paint thus produced had a storage stability of at least 6 months.

1-5. (canceled)

6. A process for producing paints which comprises adding a polymer emulsion comprising 5 to 100 ppm of 5-chloro-2-methyl-3isothiazolin-3-one having a 2-methyl-4-isothiazolin-3-one content in the range of 0 to 2 wt % based on the total amount of 5-chloro-2-methyl-4-isothiazolin-3-one to a paint.

7. A process for reducing microbial infestation of a product selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants which comprises the addition of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one to said product.

8. A process for reducing the microbial infestation of a product selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants which comprises the addition of a biocide composition having a pH in the range from pH 1 to pH 5,where said biocide composition comprises:
a) from 0.25 to 20 wt % of chloro-2-methyl-4-isothiazolin-3-one having a 2-methyl-4-isothiazolin-3-one content in the range from 0 to 2 wt %, based on the total amount of the 5-chloro-2-methyl-4-isothiazolin-3-one, and
b) a solvent.

9. A process for reducing microbial infestation of a product as defined in claim 8, comprising the steps of:
(A) providing a product having a 2-methyl-4-isothiazolin-3-one content in the range from 0 to 1 ppm, and
(B) adding 1 to 100 ppm of 5-chloro-2-methyl-4-isothiazolin-3-one having a 2-methyl-4-isothiazolin-3-one content in the range from 0 to 2 wt %, based on the total fraction of the 5-chloro-2-methyl-4-isothiazolin-3-one.

10. The process as claimed in claim 9, characterized in that in a further process step, process step, process step (C), the 5-chloro-2-methyl-4-isothiazolin-3-one is decomposed by means of at least one 5-chloro-2-methyl-4-isothiazolone-decomposing compound.

11. The process as claimed in claim 10, characterized in that in a further process step, process step (D), at least one further biocide is added.

12. The process as claimed in claim 9, characterized in that the product is selected from the group consisting of paints, interior paints, varnishes, stains, renders, plasters, emulsions, latices, polymer dispersions, lignosulfonates, chalk suspensions, mineral slurries, ceramic masses, adhesives, sealants, products containing casein, products containing starch, bitumen emulsions, surfactant solutions, fuels, cleaning products, pigment pastes and pigment dispersions, liquid inks, lithographic liquids, thickeners, cosmetic products, toilet articles, water circuits, liquids in paper processing, liquids in leather production, liquids in textile production, drilling and cutting oils, hydraulic fluids, and cooling lubricants.

13. The process as claimed in claim 10, characterized in that in process step (C) a compound is used which is selected from the group consisting of cysteine, mercaptoethanol, mercaptopropionic acid, methyl mercaptopropionate, glutathione, thioglycolate, sodium thiosulfate, sodium bisulfate, pyrithione, mercaptopyridine, dithiothreitol, mercaptoethanesulfonate, and sodium formaldehyde sulfoxylate.

14. The process as claimed in claim 11, characterized in that the biocide added in process step (D) is selected from the group consisting of 1,2-benzisothiazolin-3-one, 2-bromo-2-nitropropane-1,3-diol, zinc 2-mercaptopyridine N-oxide, a silver source, a zinc source, and 2,2-dibromo-3-nitrilopropionamide, or a mixture of two or more.
